(19) United States
(12) Patent Application Publication
(10) Pub. No.: US 2005/0052420 A1
(43) Pub. Date: Mar. 10, 2005

(54) Two-part wearable, portable, and ergonomic keyboard

(76) Inventors: Steven Excir, Toronto (CA); Kent Berkley, Largo, FL (US)

Correspondence Address: STEVEN EXCIR, 69 YONGE STREET, P.O. BOX 17008, TORONTO, ON, M5E 1Y2, CA

(21) Appl. No.: 10/655,009

(22) Filed: Sep. 5, 2003

(51) Int. Cl. G09G 5/00

(52) U.S. Cl. 345/168

(57) ABSTRACT

A two-part wearable, portable, and ergonomic keyboard is implemented as two keyboards each strapped around each thigh as shown in FIG. 1. This two-part keyboard is an accessory for entering text and data into a cell phone, a PDA, or a wearable computer. Each part of the keyboard represents a half of the conventional QWERTY keyboard as shown in FIG. 3. The configuration of the keys on the two-part flexible keyboard is kept closely resembling the ordinary conventional keyboard. However, it can also be custom-made for individuals who need more specialized keyboard configuration (e.g. FIG. 4). Furthermore, these keyboards may be worn under the clothing or over the clothing. They could be made transparent made of durable nylons or polymers, or they could be made of other waterproof fabrics. The keyboard can send data to the devices wirelessly using available technologies such as the Blue-Tooth or a radio frequency (RF) transceiver.

### BACKGROUND OF THE INVENTION

The present invention relates to the wearable, portable, and ergonomic keyboards, particularly a two-part wearable, portable, and ergonomic keyboard which is secured onto thighs of a person's body.

Information portability has been on the thinkers' minds for generations. It started by the invention of the radio and telephone. The portable phones and portable computers have come a long way to give us the freedom to access information and send them to anybody and virtually anywhere in the world. Then why do we still have to carry our laptops in large and heavy cases when the present technology assured us to make computers in the size of PDAs and cell phones? Why can't we use our PDAs to type in large massages, lecture notes, or convention speeches as quickly as we want? Cell phones have advanced a lot since their introduction too. Nowadays we can send and receive instant text massages, e-mails and even pictures and videos over the cell phones. Telecommunication and technology research companies are lately advertising their innovation, promising to give us freedom of high-bandwidth wireless technology. With all beauties, this technology possesses inside, such as sending and receiving pictures, and videos, but still we have to type text massages by our thumbs or shout to a microphone, which is virtually connected to voice recognition software, to enter a text or move the cursor around the monitor.

Of course there are portable, flexible, and foldable keyboards which are pocket sized and can be used anywhere and whenever you want to type a text into a PDA. Some examples are the new flexible keyboards or the rigid and foldable keyboards. The limitation with these portable keyboards is that you still need a supporting rigid desktop to use them. Even there is an invention called stealth keypad with only a few keys to control and enter a text, and, based on its inventor(s), it is concealed inside the palm of a person's hand. But this keypad comes short in case of the speed of typing a text and they are not in common use because of the complexity of the key representation.

A truly two-way portable information revolution has not been with us yet. Because in spite of all advances in speed of downloading and uploading still when it comes to typing a paragraph of text into a cell phone or Personal Digital Assistant (PDA) on a train, on a bus, in a convention, or in a lecture we are at the speed of turtles.

In short, we need an inputting device that is portable, flexible, and even stealthy and can be used without any external rigid desk. In addition, its key arrangement and key sizes are closely resemble those of a conventional QWERTY keyboard. It is only then that we can truly be in the valley of freedom of two-way portable information.

Then we may only need a cell phone or a wireless PDA to send and receive information, which can be stored locally on a memory flash card used on our cell phones, or it can be stored remotely on a computer at home, at office, or even on storage devices provided by the data-storage specialty companies. In addition, to monitor the text and data input and output we only need a newly commercially available non-immersive virtual display (8) embedded on eyeglasses (9). Non-immersive here means that the surrounding field of view is not blocked out, because the virtual display on the glasses subtends only a small fraction of the field of view or because it is semi-transparent or both.

### DETAILED DESCRIPTION OF THE INVENTION

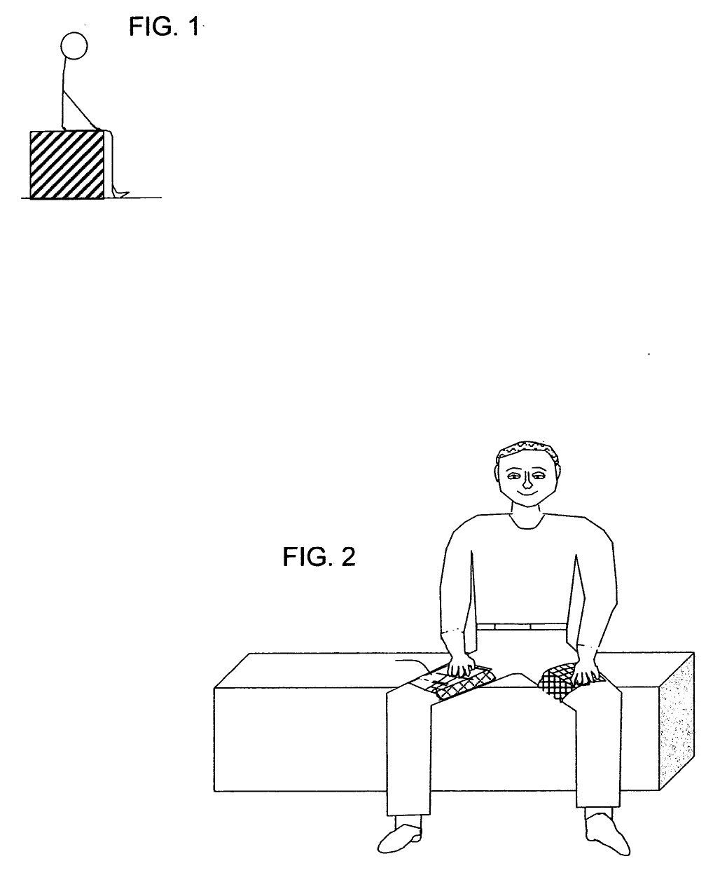

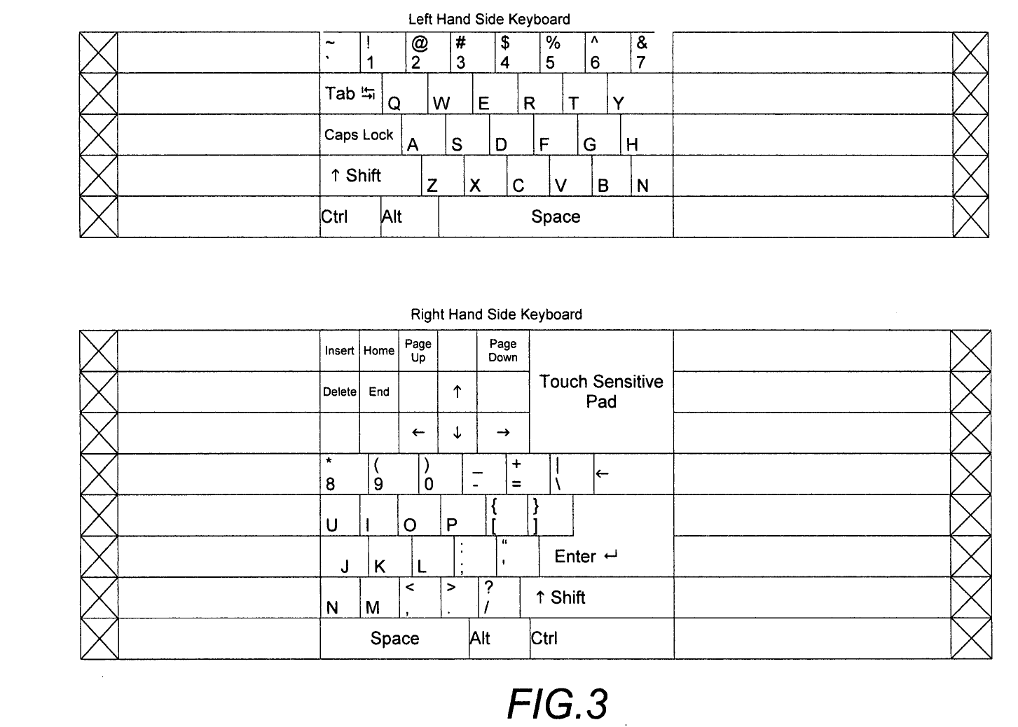

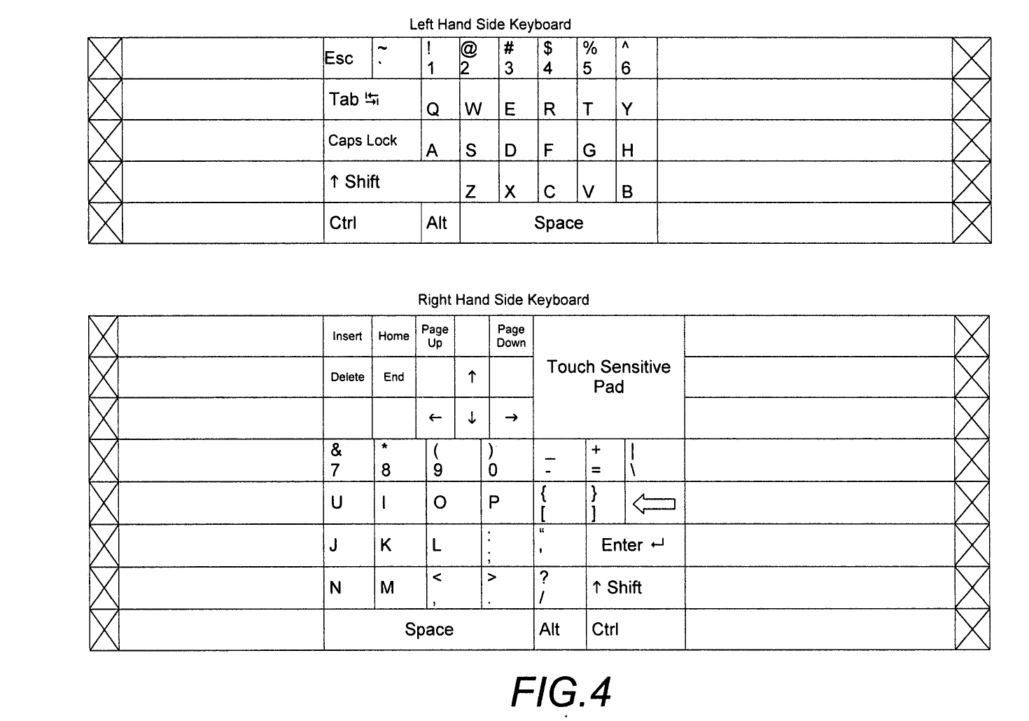

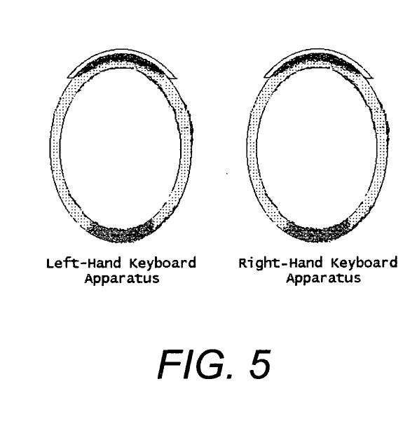

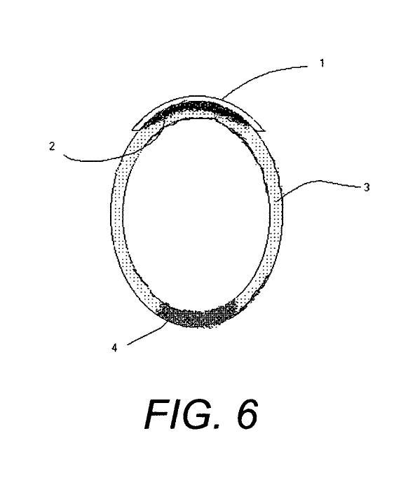

The wearable, portable, and ergonomic keyboard according to the invention is a two-part touchable keyboard, each part is strapped onto each thigh of a person's body (on the clothing or under the clothing) as shown in FIG. 1. Each partition of this innovative keyboard (1) is exact replica of corresponding half of a conventional QWERTY keyboard with the same finger size keys as shown in FIG. 3. Figures are not to scale. This arrangement is particularly advantageous to the majority of the people who are keenly used to regular desktop or laptop computer keyboards. Another variation to the arrangement of the keys on the keyboard is shown in FIG. 4.

The buffer immediately under the keyboard and above the base is made of a hard and rigid material to make the data entry accurate. Of course, the buffer can be made of a less rigid material based on customers need. In addition, the buffer may be segmented to make the keyboards foldable. The base and straps (3) of this unique keyboard is made of soft plastic or rubber or a durable and waterproof fabric. The locking mechanism (4) is made in many conceivable shapes and forms. Some of the variations are like those protective gears' locking mechanism, or belt buckles.

Another variation of the keyboard can be made of transparent material such as durable plastics or the new polymers. The electrical contacts inside each transparent key are either transparent themselves, made of the new available conductive polymers, or non-transparent but very thin cupper wires. We prefer the transparent variation of the keyboard because it is stealthy. Because these keyboards are almost invisible their base, straps, and locking mechanism can also be transparent plastic or polymers. Furthermore, these transparent keyboards can also be made to stick to the clothing by means of fabric-adhesive. The keyboard is pilled off whenever is necessary and put backed on the clothing as needed. Basically, any variation of materials can be used for the base of the keyboard, but the keyboard itself must be water-proof, light, durable, and reusable to make this inventive product popular and in common use.

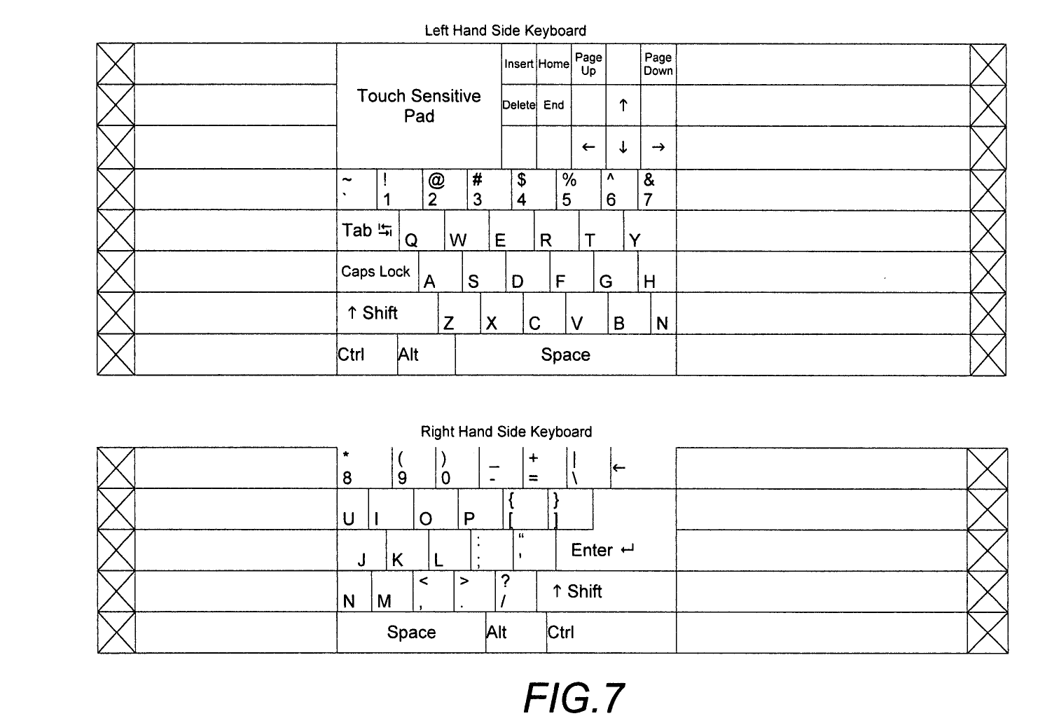

The right-hand side of the keyboard as shown in FIG. 3 and FIG. 4, has an embedded pressure sensitive area (5), like the ones made for laptops, and some extra keys (6) for convenience. FIG. 7 shows a variation of this keyboard which includes the pressure sensitive area on the left keyboard. Still, another variation of this keyboard may include a small track-ball.

Another variation to make these keyboards even more stealthy is to wear them under the clothing like elastic sport shorts' legs. In this case, special attention must be made to the material of the base. Obviously, this variation is more attractive for experienced keyboard users who type without looking at the keyboard. Furthermore, attention must be made in designing the circuitry of these keyboards to make them heat tolerant because of the body heat.

The manually entered text and data is sent to the cell phone, PDA, or any electronic device by means of either a separable keyboard cable (e.g. USB cable, RS-232), or more conveniently wirelessly. The keyboard circuitry can send data to the devices wirelessly using already available technologies such as the Blue-Tooth or a radio frequency (RF) transceiver. However, attention must be made to the security of the data on the wireless case. For example, the data must be coded for each individual keyboard. The coding password may be hard-coded in the keyboard circuitry or can be changed as frequent as need by the owners of the keyboards. The integrated circuitry used inside these keyboards is made of durable flexible circuit boards.

Of course, when using a two-part wearable keyboard, the two hands will be occupied in typing the data into the electronic device. One way to monitor the data entered, the cell phone, PDA, or a portable monitor is placed on a desktop. However, the main idea behind this invention was to make the text entry into cell phones, and PDAs much faster, easier, and portable for people sitting or standing on trains, on buses, or in the meetings such as seminars and conventions. So, to use this inventive and original keyboard to its fullest potential we propose to monitor the text and data entry via the recently commercially available non-immersive virtual displays (8) embedded on eyeglasses (9). Non-immersive here means that the surrounding field of view is not blocked out, because the virtual display on the glasses subtends only a small fraction of the field of view or because it is semi-transparent or both. These commercially available devices used with the inventive two-part wearable keyboard will make the information portability a reality at last.

1. A two-part wearable, portable, and ergonomic keyboard which are strapped onto the upper legs [thighs] of a person (on the clothing or under the clothing), and is used to enter text and data into the electronic devices such as cell phones, Personal Digital Assistants (PDAs), or portable computers with a cable attachment or a secured wireless means comprising:
a couple of leg straps;
a couple of mounts;
two sets of plurality of depressible keys on said mounts, each said set of keys arranged as half of a QWERTY said keyboard format;
a couple of wireless electronic communicating devices embedded into said mounts.

2. A two-part wearable, portable, and ergonomic keyboard which are strapped onto the upper legs [thighs] of a person (on the clothing or under the clothing), and is used to enter text and data into the electronic devices such as cell phones, Personal Digital Assistants (PDAs), or portable computers with a cable attachment or a secured wireless means comprising:
a couple of mounts that were sewn or adhered to clothing;
two sets of plurality of depressible keys on said mounts, each said set of keys arranged as half of a QWERTY said keyboard format;
a couple of wireless electronic communicating devices embedded into said mounts.

3. A two-part wearable, portable, and ergonomic keyboard as defined in claim 2 wherein said plurality of keys is made from transparent plastics or polymer and encapsulated between two sets of weatherproof material.
